(19) United States
(12) Patent Application Publication
(10) Pub. No.: US 2004/0136751 A1
(43) Pub. Date: Jul. 15, 2004

(54) Image forming apparatus

(75) Inventors: Hidenori Sunada, Toride-Shi (JP); Eiichi Motoyama, Tokyo (JP); Yoshihito Osari, Tokyo (JP); Satoru Yamamoto, Toride-Shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/689,653

(22) Filed: Oct. 22, 2003

Related U.S. Application Data
(63) Continuation of application No. PCT/JP03/12410, filed on Sep. 29, 2002.

(30) Foreign Application Priority Data
Sep. 30, 2002 (JP) 285221/2002

(51) Int. Cl. G03G 15/00

(52) U.S. Cl. 399/167

(57) ABSTRACT

An image forming apparatus includes an apparatus main assembly, and a process cartridge detachably mountable to the apparatus main assembly, including driving force receiving means to be connected to driving means of the apparatus main assembly and a noncontact memory for carrying out noncontact data communication with receiving means of the apparatus main assembly, wherein the apparatus main assembly performs rotational drive of the drive means before reading out data from the noncontact memory.

### TECHNICAL FIELD

The present invention relates to an image forming apparatus including a process cartridge which is detachably mountable to a main assembly of the image forming apparatus, particularly an image forming apparatus which permits data communication between a noncontact memory mounted process cartridge and the apparatus main assembly.

### BACKGROUND ART

For example, in an ordinary image forming apparatus, such as a copying machine, a printer or the like, a load unit constituting a part of an image forming means, such as a photosensitive drum or an intermediary transfer belt, is rotationally driven by transmitting thereto a driving force (power) through a coupling or connection mechanism disposed between such a load unit and a driving source of the main assembly of the image forming apparatus. Such a load unit reaches the end of its life due to wear and/or deterioration with time. The life of the load unit is shorter than that of the image forming apparatus main assembly, so that there is a need to be replaced with new one on several occasions until it reaches the end of life. For this reason, the load unit is used in the form of a cartridge in view of ease in mounting and demounting in many cases.

In recent years, a memory is provided in the cartridge so as to have the following functions (1), (2) and (3):

(1) In the memory, data such as initial characteristics of the unit at the time of production thereof, identifying (discriminating) information thereof, or the like are stored, and the data are used for switching control specifications for the photosensitive drum, or the like in the cartridge,

(2) In the memory, data on an operation time of the unit is stored and used for judging its replacement timing, and

(3) In the memory, same fluctuation values varying depending on durability factors of the unit, and optimum image formation is performed on the basis of the most up-to-date values.

As a result, the memory is utilized for improving image qualities of the image forming apparatus.

As the memory for such a purpose, a noncontact memory is used in main cases since it has the advantages of, e.g., high reliability of point of contact attributable to high resistance to mounting/demounting operations and of a simple circuit structure. This is because, the noncontact memory carries out communication with the apparatus main assembly by transmission and reception of electromagnetic wave between antennas provided in both the apparatus main assembly and the memory, so that the noncontact memory does not need contact between metal terminals as is a conventional memory, thus causing no problems about contact of terminals, such as noise, toner contamination, various vibrations, or the like.

With respect to the access procedure of the image forming apparatus to the noncontact memory provided in the memory as described above, Japanese Laid-Open Patent Application (JP-A) 2002-149039 has proposed that a state of means for transmitting electromagnetic wave to the noncontact memory is switched on the basis of a detection result of an open/close door for causing a detachably mountable load unit to be mounted to and demounted from an apparatus main assembly. In other words when the door is opened, communication is stopped since there is a possibility that the load unit is removed, and on the other hand, when the door is closed, the communication is started since there is a possibility that the load unit is mounted.

However, in the case where the load unit is mounted at the time when the door is closed, a state of permitting communication with reliability is not necessarily optimum. When a user mounts the load unit into the apparatus main assembly by opening the door, it is by a no means easy to mount it at a predetermined position accurately at the time of image formation. This is because a drive portion of the load unit to be connected to the apparatus main assembly is required to provide a high accuracy of position. In other words, allowance for position is very small.

On the other hand, such a concept that a structure wherein the apparatus main assembly is automatically moved to a predetermined position at the time of image formation by transmitting a driving force to the load unit in an image forming operation is employed so as to obviate the necessity for the user to take the trouble to accurately mount the load unit, is also related. Accordingly, there is a somewhat positional deviation of the load unit with respect to the apparatus main assembly immediately after the door is closed. As a result, an antenna on the load unit side is not necessarily located in a identical position.

Each in such a positional relationship, it is considered that a receiving sensitivity or a sending power of the antenna is increased in order to permit reliable communication before carrying out necessary operation for image formation. However, in this case, size reduction of the load unit becomes difficult, and there arises a possibility that an increase in sending powder causes interference with an unindended antenna or leakage of electromagnetic wave to the outside of the image forming apparatus in some cases. FOr this reason, in view of measures against these problems, it cannot be said that communication is ensured even when the position of the load unit is somewhat deviated. DISCLOSURE OF THE INVENTION

An object of the present invention is to provide an image forming apparatus capable of providing a high stability in communication between a noncontact memory of a process cartridge and an apparatus main assembly.

According to the present invention, there is provided an image forming apparatus, comprising:

an apparatus main assembly, and

a process cartridge detachably mountable to the apparatus main assembly, including driving force receiving means to be connected to driving means of the apparatus main assembly and a noncontact memory for noncontact data communication with receiving means of the apparatus main assembly,

wherein the apparatus main assembly performs rotational drive of the drive means before reading out data from the noncontact memory.

This and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic cross-sectional view of a general structure of the image forming apparatus of the present invention.

FIGS. 2 and 3 are a front view and a perspective view, respectively, of a coupling on a process cartridge side.

FIG. 4 is a perspective view of a coupling on a stepping motor side.

FIG. 5 is a schematic sectional view showing the coupling on the process cartridge and the coupling on the stepping motor opposite to and to be connected with each other.

FIG. 6 is a schematic view of a general structure of the process cartridge.

FIG. 7 is a schematic block diagram showing a general structure of the image forming apparatus.

FIG. 8 is a schematic block diagram showing a general structure of a noncontact memory.

FIG. 9 is a schematic sectional view for illustrating a positional relationship between antennas of the noncontact memory and the image forming apparatus main assembly when the process cartridge is drawn in the apparatus.

FIG. 10 is a schematic perspective view of the image forming apparatus.

### BEST MODE FOR CARRYING OUT THE INVENTION

Hereinbelow, embodiments of the image forming apparatus according to the present invention will be described with reference to the drawings. In the drawings, identical reference numerals or symbols represent identical members or functions, and repeated explanations therefor are omitted as desired.

<Embodiment 1>

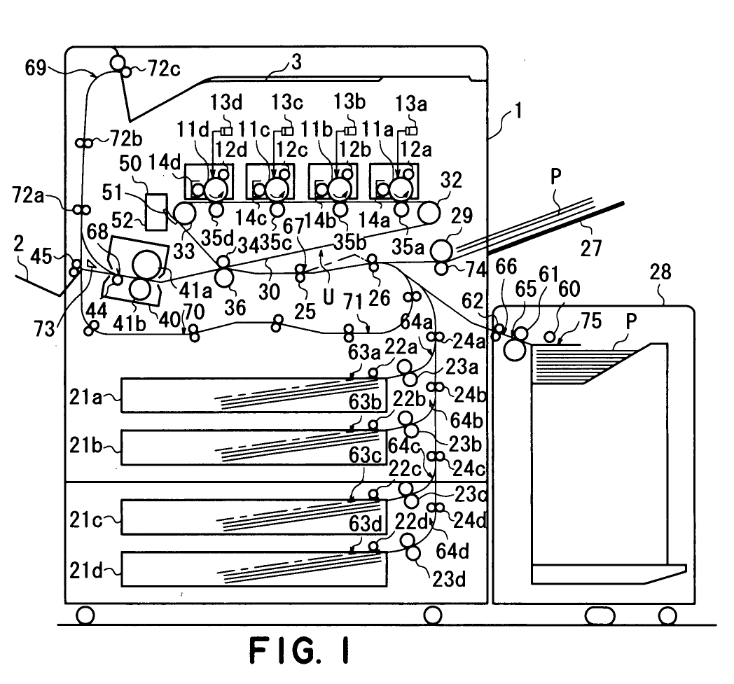

FIG. 1 is a cross-sectional view showing a four color-based full color printer as an embodiment of the image forming apparatus of the present invention.

Referring to FIG. 1, a printer 1 (hereinafter, referred to as “image forming apparatus”) includes an image forming apparatus main assembly 1 which roughly includes four image forming stations a, b, c and d disposed in parallel with each other, a paper supply means; an intermediary transfer means, a conveyance means; a fixing unit; an operation means; and control means (not shown). The respective image forming stations a, b, c and d have the same structure.

More specifically, the image forming stations a b, c and d include drum type electrophotographic photosensitive members (hereinafter, referred to as “photosensitive drum(s)”) 11a, 11b, 11c and 11d, as an image bearing member. Each of the photosensitive drums 11a to 11d is supported by a central axis (shaft) and rotationally driven in a direction of an arrow by a stepping motor and each of the photosensitive drums 11a to 101d, couplings for transmitting a rotational force are used.

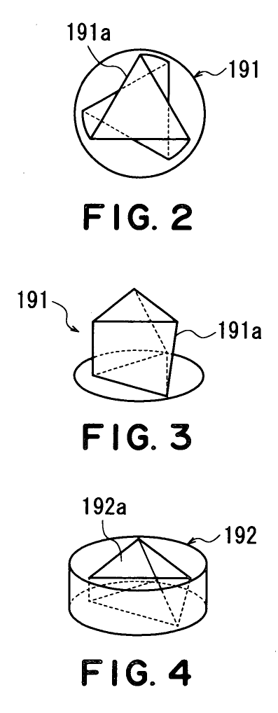

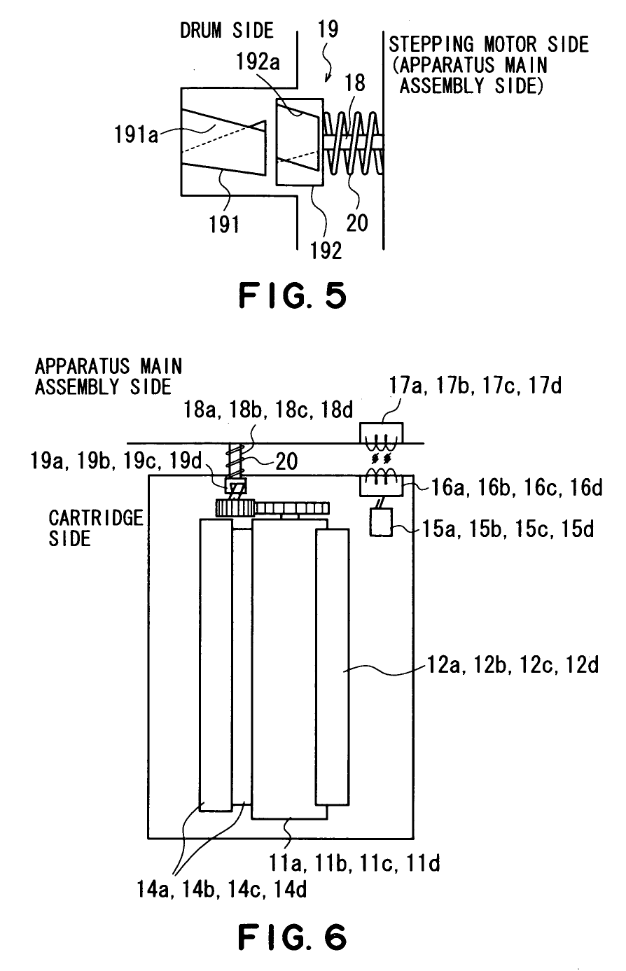

The structure of the couplings will be described with reference to FIGS. 2-5, wherein FIG. 2 is a front vie of the coupling on the photosensitive drum side, FIG. 3 is a corresponding perspective view, FIG. 4 is a perspective view of the coupling on the stepping motor side, and FIG. 5 is a view showing a state that the couplings on the photosensitive drum side and the stepping motor side are disposed opposite to and to be connected with each other.

A coupling 19 (19a, 19b, 19c and 19d) is constituted by engaging a coupling 191 on the photosensitive drum side and a coupling 192 on the stepping motor side.

The coupling 191 on the photosensitive drum side is formed in such a shape that a triangle pole 191a is twisted as shown in FIGS. 2 and 3, and on the other hand, the coupling 192 on the stepping motor side is provided with a triangular hole 192a for engaging the twisted triangle pole 191a therein. These couplings 191 and 192 are used in combination, as shown in FIG. 5, so that the twisted triangle pole 191a of the coupling 191 on the photosensitive drum side is disposed opposite to the triangular hole 192a of the coupling 192 on the stepping motor side to engage the triangle pole 191a with the triangular hole 192a to connect both couplings 191 and 192 to each other. As a result, a driving force of the stepping motor can be transmitted to the photosensitive drum (11a, 11b, 11c and 11d) through the coupling 19.

Incidentally, in the case where the position of the triangular hole 192a of the coupling 192 is not in alignment with the position of the triangle pole 191a of the coupling 191 when the photosensitive drums 11a to 11d are set, the photosensitive drum 11a to 11d are accommodated in the image forming apparatus main assembly 1 by compression of a spring 20 shown in FIG. 5. Thereafter, the triangular hole 192a of the coupling 192 on the stepping motor side is rotated when the stepping motor is rotated, whereby the triangle pole 191a of the coupling 191 on the photosensitive drum side is engaged in the triangular hole 192a of the coupling 192 on the stepping motor side (at this time the spring 20 expands) at a timing of positional alignment of the triangular hole 192a with the triangle pole 191a of the coupling 191 on the photosensitive drum side. As a result, the driving force of the stepping motor is transmitted to the photosensitive drums 11a to 11d.

The size of the triangular hole 192a of the coupling 192 on the stepping motor side is designed to be somewhat larger than that of the triangle pole 191a of the coupling 191 on the photosensitive drum side, and the triangle pole 191a and the triangular hole 192a are twisted. As a result, when the coupling 191 shown in FIG. 2 is rotated clockwise, a force acts in such a direction that the engaging triangle pole 191a is pulled into the triangular hole 192a, whereby a connection or coupling portion between the stepping motor and the photosensitive drum (11a to 11d) is locked.

On the other hand, when the coupling 191 is rotated counterclockwise, a force acts in such a direction that the triangle pole 191a is pushed out of the triangular hole 192a, so that the connection (coupling) between the stepping motor and the photosensitive drum is released. However, when the coupling 191 is rotated slightly counterclockwise in the connection state, it is possible to cause the photosensitive drums 11a to 11d to remain stationary although the locked connection is released by clearance created due to a difference in size between the triangle pole 191a and the triangular hole 192a.

Based on such a structure of the coupling 19 (191, 192), the coupling 191 has such a property that it is locked to retain the connection state when the photosensitive drum is rotationally driven in the direction of the arrow (in the ordinary rotational direction) at the time of image formation by normal rotation of the stepping motor, and on the other hand, that the lock is released to release the connection state when the stepping motor is (reversely) rotated in the direction opposite from the arrow direction.

Incidentally, around the photosensitive drums 11a to 11d, along in their rotational directions, charge roller (charging means) 12a, 12b, 12c and 12d; scanners (exposure means) 13a, 13b, 13c and 13d; and developing apparatuses (developing means) 14a, 14b, 14c and 14d are disposed substantially in this order.

The charge rollers 12a to 12d impart electric charges with uniform amount of charge to the surfaces of the photosensitive drums 11a to 11d, respectively, to electrically charge uniformly the photosensitive drums 11a to 11d, respectively, to a predetermined polarity and a predetermined potential.

The photosensitive drums 11a to 11d after the charging process are irradiated with a light beam, such as a laser beam, which has been modulated depending on picture (image) information. As a result, on the photosensitive drums 11a to 11d, electric charges at their irradiation portion are removed to form electrostatic images.

The electrostatic images are visualized (developed) as (color) toner images by the developing apparatuses 14a, 14b, 14c and 14d containing therein developers (toners) of yellow, cyan, magenta and black, respectively. The developed toner images are successively transferred onto an intermediary transfer belt 30.

Through the above-mentioned processes, image forming operations with the respective color toners are successively performed. At the time of image formation, various values as to thee image forming operations are stored in a memory (not shown).

The paper supply means includes a portion for accommodating a recording material P (e.g., paper or a transparent film), a roller for conveying the recording material P, a sensor for detecting passing of the recording material P, a sensor for detecting the presence/absence of the recording material P, and a guide (not shown) for conveying the recording material P along a conveyance passage.

In FIG. 1, the apparatus main assembly 1 includes paper feed cassettes 21a, 21b, 21c and 21d; a manual feed tray 27; and a paper feed deck 28. In these members, the recording material P is held. The apparatus main assembly I further includes pickup rollers 22a, 22b, 22c and 22d for feeding the recording material one by one from the paper feed cassettes 21a to 21d, respectively. These pickup rollers 22a to 22d feed a plurality of sheets of the transfer material P in some cases put only one sheet is separated with reliability from the fed sheets of the transfer material by BC rollers 23a, 23b, 23c and 23d, respectively.

The thus-separated only one sheet is conveyed to registration rollers 25 through drawing rollers 4a, 24b, 24c and 24d, and preliminary registration rollers 26. The recording material P held in the manual feed tray 27 is separated one by one by a BC roller 29 and conveyed to the registration rollers 25 through the preliminary registration rollers 26. Further, a plurality of sheets of the recording material held in the paper feed deck 28 ar fed to a paper feed roller 61 through a pickup roller 60 and are separated one by one by the paper feed roller 61 with reliability, thus being carried to the registration rollers 25.

Then, an intermediary transfer unit (load apparatus) U will be described.

The intermediary transfer unit U includes the intermediary transfer belt 30 as the intermediary transfer member. As a material for the intermediary transfer belt 30, for example, PET (polyethylene terephthalate), PVDF (polyvinylidene difluoride), or the like are used. The intermediary transfer belt 30 is extended around a drive roller 32, a tension roller 33 and a secondary transfer opposite roller 34.

The drive roller 32 is a roller for transmitting a driving force to the intermediary transfer belt 30 and rotationally drives the intermediary transfer belt 30 in a clockwise direction. The tension roller 33 is a roller for exerting an appropriate tension on the intermediary transfer belt 30 under the action of a pressing force of a spring (not shown). The secondary transfer opposite roller 34 and a secondary transfer roller 6 sandwich therebetween the intermediary transfer belt 30 so as to create a secondary transfer nip (secondary transfer station) therebetween.

The drive roller 32 is prepared by coating the surface of a metal roller with several mm-thick layer of rubber (of urethane or chloroprene), thus preventing slipping with the intermediary transfer belt 30. The drive roller 30 is rotated by transmitting a rotating force thereto from the secondary transfer for rotationally driving the photosensitive drums 11a to 11d and is also provided with a coupling (not shown) as a transmission means. This coupling is also locked when the photosensitive drums 11a to 11d are rotated in the arrow direction similarly as in the couplings 19 used for the photosensitive drums 11a to 11d, and is designed to release the lock by being rotated in a direction opposite to the arrow direction.

On the backside of the intermediary transfer belt 30 at positions where the photosensitive drums 11a to 11d and the intermediary transfer belt 30, primary transfer rollers 35a, 35b, 35c and 35d to which a high voltage for transferring the toner image onto the intermediary transfer belt 30 is applied, and disposed, respectively.

The secondary transfer roller 36 is pressed against the intermediary transfer belt 35 under an appropriate pressure. Downstream fro the secondary transfer roller 36 along the rotational direction of the intermediary transfer belt 30, a cleaning apparatus 50 for cleaning the surface (onto which the toner image is transferred) of the intermediary transfer belt 30 is disposed. The cleaning apparatus 50 includes a cleaner blade 51 (of, e.g., an urethane rubber) and a waste-toner box 52 for containing therein waste toner.

A fixing unit 40 includes a fixing roller 41a containing therein a heat source such as a halogen heater or the like, a pressure roller 41b which is pressed against the fixing roller 41a and optionally provided with a heat source, and an inner paper output roller 44 for conveying the recording material P which has been discharged from these fixing and pressure rollers 41a and 41b.

On the other hand, the recording material P conveyed to the registration rollers 25 is once stopped by terminating the rotational drive of the upstream rollers, and then the upstream rollers and the registration rollers 25 are rotationally driven gain at a timing of image formation at the image forming station. The recording material P is sent to the stationary transfer nip, Where the toner images on the intermediary transfer belt 30 are simultaneously transferred onto the recording material P.

The toner image on the recording material P after being subjected to the secondary transfer process is fixed by the fixing unit 40, and the recording material P is passed through the inner paper output roller 44 and then its conveyance direction is switched by a switching flapper 73. In the case where the switching flapper 73 is located on a face up output side, the recording material P is discharged in a face up paper output tray 2 by an outer paper output roller 45. On the other hand, in the case where the recording material P is located on a face down output side, the recording material is conveyed in the direction of reverse rollers 72a, 72b and 72c and discharged in a face down paper output tray 3.

Incidentally, in the conveyance passage of the recording material P, a plurality of sensors for detecting passing of the recording material P are disposed. The sensors include paper feed retry sensors 64a, 64b, 64c and 64d; deck paper feed sensor 65; a deck drawing sensor 66; a registration sensor 67; an inner paper output sensor 68; a face down paper output sensor 69; double-side preliminary registration sensor 70; double-side paper re-feed sensor 71; etc. Further, to the paper feed cassettes 21a to 21d for accommodating the recording material P, cassette paper presence/absence sensors 63a, 63b, 63c and 63d for detecting the presence or absence of the recording material P are disposed. To the manual feed tray 27, a manually fed paper presence/absence sensor 74 for detecting the presence or absence of the recording material on the manual feed tray 27. In the paper feed deck 28, a deck paper presence/absence sensor 75 for detecting the presence or absence of the recording material P in the deck 28 is disposed.

The control means includes a control board (not shown) for controlling operations of mechanisms in the respective units and a motor drive board (not shown) or the like. The stepping motor used in this embodiment is also controlled by this control means with respect to its rotational direction (normal/reverse) and rotational angle (revolution number). The control means further includes a timer.

The operation means 4 is disposed on the upper surface of the image forming apparatus main assembly 1 and permits selection of the paper feed stations (paper feed cassettes 21a to 21d, manual feed tray 27, and paper feed deck 28), selection of paper output trays (face up tray 2 and face down tray 3) and designation of tab set.

Next, the operation of the image forming apparatus having the above-described structure will be explained. In the following, the case of feeding the recording material P from the paper feed cassette 21a will be described as an example.

After lapse of a predetermined time, timed by a timer, from transmission of an image forming operation start signal, the recording material P is sent one by one from the paper feed cassette 21a by the pickup roller 22a and then is conveyed to the registration rollers 25 by the paper feed roller 23a through the drawing roller 24a and the preliminary registration roller 26. At this time, the registration roller 25 ar stopped and a leading end of the recording material P reaches the nip between the registration rollers 25. Thereafter, the registration roller 25 start rotation at a timing of start of image formation at the image forming station. The rotation timing is set so that the recording material P and the toner image, which has been primary-transferred onto the intermediary transfer belt 30 at the image forming station, meet just at the secondary transfer nip.

On the other hand, at the image forming station, when the image forming start signal is sent, the toner image formed on the photosensitive drum 11d which is located most upstream in the rotational direction of the intermediary transfer belt 30 is primary-transferred onto the intermediary transfer belt 30 at a primary transfer station by a transfer roller 35d supplied with a high voltage, through the above-mentioned process. The primary-transferred toner image is conveyed to a subsequent primary transfer station, at which image formation is performed, after lapse of a time for conveying the toner image between first and second image forming stations, so that a subsequent toner image is transferred and superposed on the conveyed toner image with its leading end in alignment with that of the conveyed toner image. A similar process is repeated for remaining colors, so that four color toner images are finally primary-transferred and superposed onto the intermediary transfer belt 30.

Thereafter, when the recording material P is fed to the secondary transfer nip to contact the intermediary transfer belt 30, a high voltage is applied to the intermediary transfer roller 36 at a timing of passing of the recording material P, whereby the four color toner images formed on the intermediary transfer belt 3 through the above-mentioned processes are transferred onto the recording material P at the same time. Thereafter, the recording material P at the same time. Thereafter, the recording material P is guided to a nip between the fixing roller 41a and the pressure roller 41b of the fixing unit 40. The toner image is heated and pressed by the fixing and pressure rollers 41a and 41b, thus being fixed on the surface of the recording material P. The recording material P on which the toner image is fixed is then discharged in the face up tray 2 or the face down tray 3 depending on the switching direction of the switching flapper 73.

FIG. 6 is a schematic structural view of the process cartridge (drum cartridge) to which the noncontact memory is mounted.

The drum cartridge is a unit, as a cartridge, including each of the photosensitive drums 11a to 11d, each of the charge rollers 12a to 12d, and each of the developing apparatuses 14a to 14d, at each of the image forming stations a to d.

The image forming apparatus main assembly 1 transmits a power to the photosensitive drums 11a to 11d through the driving shafts 18a to 18d and the couplings 19a to 19d. The image forming apparatus main assembly 1 also transmits a power to the charge rollers 12a to 12d and the developing apparatuses 14a to 14d through other driving shafts and couplings (not shown).

Further, in the respective drum cartridges, nonvolatile memory circuits 15a, 15b, 15c and 15d and antennas 16a, 16b, 16c and 16d are mounted on the same side as the couplings to which the driving force is transmitted from the driving shafts. Also on the image forming apparatus main assembly 1 side, antennas 17a, 17b, 17c and 17d are disposed opposite to the antennas 16a, 16n, 16c and 16d, respectively. In the case where a gap between each of the antennas 16a to 16b and each of the antennas 17a to 17d is sufficiently small, when an external magnetic field is formed by the antennas 17a to 17d on the image forming apparatus main assembly side, an induction current is generated in the antennas 16a to 16d on the drum cartridge side by the magnetic field. The induction current not only supplies a power to the nonvolatile memory circuits 15a to 15d but also adds a signal component to the magnetic field, thus permitting reading out and writing of data stored in memories of the nonvolatile memory circuits 15a to 15d.

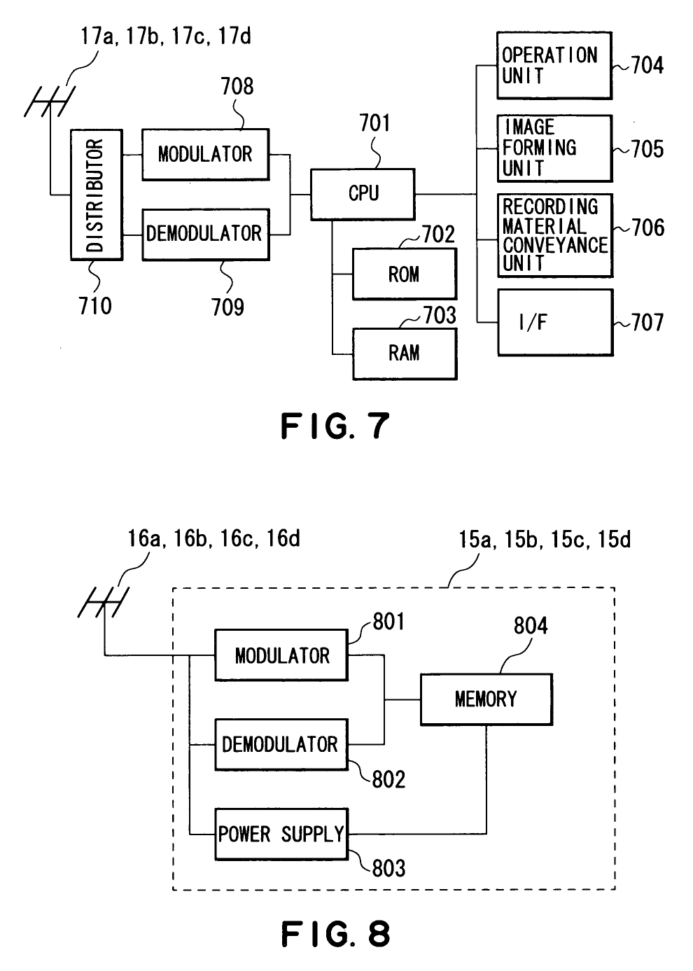

FIG. 7 is a block diagram showing the general structure of the image forming apparatus main assembly 1.

Referring to FIG. 7, the image forming apparatus main assembly 1 includes a CPU (central processing unit) 701 for carrying out an essential control of the image forming apparatus main assembly 1. To the CPU 700, an ROM (read-only memory) 702 in which a control program is written and an RAM (random-access memory) 703 as a working storage for performing processing are connected through an address bus and a data bus. Also to the CPU 701, an operation unit 704 as display means and key input means for the image forming apparatus main assembly 1, an image forming unit 705 for controlling the above-mentioned various processes regarding image formation, a recording material conveyance unit 706 for controlling conveyance of the recording material P onto which an image is formed, and an I/F (interface) 707 as a communication I/F between the image forming apparatus main assembly 1 and external units, are connected. The CPU 701 reads out information for processing from the ROM 702 on the basis of the input information from the operation unit 704 or the I/F 707, and executes the image forming operation on the recording material P successively.

Further, the image forming apparatus main assembly 1 includes, as a noncontact memory interface, a modulator 708, a demodulator 709, a distributor 710, and antennas 17a, 17b, 17c and 17d. The noncontact memory interface has such functions that a signal modulated by the modulator 708 on the basis of a control signal from the CPU 701 is sent from the antennas 17a to 17d to the drum cartridge side through the distributor 710 and that a signal received by the antennas 17a to 17d is demodulated by the demodulator 709 through the distributor 710 and is sent to the CPU 701.

FIG. 8 is a block diagram showing the general structure of the noncontact memory including nonvolatile memory circuits 15a to 15d and antennas 16a to 16d on the drum cartridge side.

In the noncontact memory, signals transmitted from the antennas 17a to 17d are received by the antennas 16a to 16d, respectively, and a power required for actuating the nonvolatile memory circuits 15a to 15d is generated by a power supply 803. At the same time, the signal received by a demodulator 802 is demodulated, and reading out and writing of data stored in a memory 804 are performed. A data read out from the memory 804 is modulated by a modulator 801 and is sent to the image forming apparatus main assembly side.

Then, features of this embodiment, i.e., processing performed at the time when reading out of data stored in the noncontact memory mounted in the drum cartridge is effected in a close state of a cover of the image forming apparatus main assembly will be described.

The lives of the photosensitive drums 11a to 11d, the charge rollers 12a to 12d, and the developing apparatuses 14a to 14d assembled in the drum cartridges are sufficiently shorter than the operation life of the image forming apparatus main assembly 1, so that thee members are designed to be simultaneously replaceable for each drum cartridge so as to facilitate replacement operation of these members which have reached the ends of their lives. In such cases, it is desirable that the replacement of each of the drum cartridges can be performed at an appropriate timing by counting the number of operation for each drum cartridge so as to correctly determine the end of the life and outputting a display calling user's attention to the replacement of the drum cartridge which has reached the end of the life on the operating means 4, as a warning message of the operation life of the drum cartridge at the time when the drum cartridge has reached the end of the life.

As the number of operation for the respective drum cartridges, it is possible to use the number of sheets of the recording material subjected to image formation, an energization time, a cumulative image density, etc. Such values are required to be held even when the image forming apparatus is not energized, and in view of a possibility that a drum cartridge is used in mid stream for another image forming apparatus an ease of handling, various information on the number of operation are stored in the noncontact memory mounted in the drum cartridge. Further, by using the noncontact memory, a problem of contact reliability of terminals caused due to repetition of mounting/demounting operations of the drum cartridge is solved.

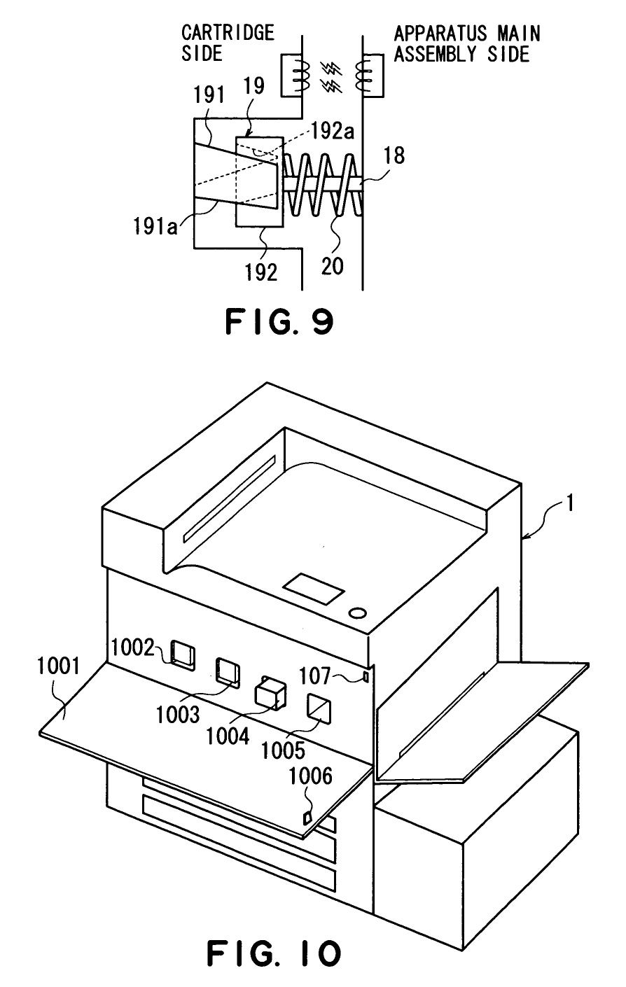

In a state after the drum cartridges are mounted in the image forming apparatus main assembly and the stepping motor is rotated, as described above, the drum cartridges have already been drawn by a drawing force of the driving shafts, whereby, as shown in FIG. 9, the triangle pole 191a of the coupling 191 on the drum cartridge side enters the triangular hole 192a of the coupling 192 of the stepping motor side as far as it will go. For this reason, a maximum spacing between the antennas 16a to 16d of the drum cartridges and the antennas 17a to 17d of the image forming apparatus main assembly corresponds to the sum of a fixed value as such a distance at the time when the triangular pole 191a enters the triangular hole 192a as far as it will go at the coupling portions (191, 192) and a distance of the driving shaft 18 (18a to 18d) on the stepping motor side at the time when the spring 20 expands to its full lengths. Accordingly, a communication ability of the antennas 16a to 16d and 17a to 17d may be designed so as to permit a communication, with reliability at a minimum level, at such a distance between the antennas 16a to 16d and the antennas 17a to 17d in the above-mentioned state, thus being not required to be more than the above level.

Incidentally, the drum cartridges are designed to be mounted by inserting them from the front side to the back side on the drawing (FIG. 1). As is apparent from the perspective view of the image forming apparatus main assembly 1 shown in FIG. 10, it is necessary to open a front door 1001 of the image forming apparatus main assembly 1 in order that the drum cartridges are mounted in the demounted from drum cartridge mounting portions 1002 to 1005.

When the front door 1001 is closed, an open/close detection pin 1006 is inserted into a hole 1007 for the detection pin, and when the front door 1001 is opened, the detection pin 1006 is disengaged from the hole 1007. Accordingly, a sensor (not shown) is provided at a deep position of the hole 1007 to detect the presence or absence of the open/close detection pin 1006, thus detecting the opening and closing of the front door 1001. More specifically, it is possible to detect not only the opening of the front door 1001 by an output of the front door open/close detection sensor at any time when the drum cartridge is replaced but also the closing of the front door 1001 by an output of the sensor at any time when the front door 1001 is closed after the replacement of the drum cartridge(s) is completed, as long as the image forming apparatus is energized.

Accordingly, when the front door 1001 is shifted from the open state to the close state by reference to the output of the front door open/close detection sensor, the image forming apparatus main assembly 1 rotates the stepping motor in the image forming direction and then is slightly rotated reversely in order to transmit the driving force to the drum cartridges, thus drawing therein the drum cartridges through the couplings. As a result the image forming apparatus main assembly 1 is placed in a state that it is capable of communicating with the noncontact memories mounted in the drum cartridges with reliability. The reason why the stepping motor is slightly rotated reversely to release the connection at the couplings is because the, drum cartridges can always be taken out when the front door 1001 is opened at the time other than image formation, even in a power-off state.

Further, this operation is always performed irrespective of the presence or absence of the drum cartridges. Thereafter, the image forming apparatus main assembly 1 reads out data of the memories stored in the noncontact memories by using the antennas 16a to 16d and 17a to 17d having the minimum communication ability as described above. If the data is correctly read out, on the basis of the data, the image forming apparatus main assembly 1 prepares for the image forming operation. On the other hand, if the data is not correctly read out, on the basis of the resultant data, the image forming apparatus main assembly 1 performs such a treatment for the absence of the drum cartridge to be originally mounted as a result of judgment that there is photosensitive drum or an incorrect drum cartridge is mounted.

As described above, when the detection result of the cover (front door) required to be opened or closed for mounting the drum cartridge(s) is shifted from the open state to the close state, the rotating shaft for transmitting the rotational driving force to the drum cartridge(s) is rotationally driven, whereby it becomes possible to immediately place the drum cartridges and the image forming apparatus main assembly in a state that they are capable of communicating with each other with reliability by performing a minimum transmission and reception of electromagnetic wave therebetween.

<Embodiment 2>

An image forming apparatus of this embodiment performs the same operations as in that of Embodiment 1 except for an operation, after the image forming apparatus is turned on, which is specifically described below.

In a state that the power of the image forming apparatus is not turned on, it is impossible to judge that any specific drum cartridge is mounted in the image forming apparatus main assembly. Further, the front door open/close detection sensor is in an undetectable state, so that there is a possibility that the triangle pole and the triangular hole are appropriately engaged with each other at the (coupling) portion between the stepping motor and the photosensitive drum by performing mounting/demounting of the drum cartridge during the power-off state.

As a result, assuming that the mounting state of the drum cartridge is unspecified at the time of turning the power on, it is possible to move an antenna for a noncontact memory mounted in the drum cartridge to a position which permits communication of the antenna with an antenna provided in the image forming apparatus main assembly when the drum cartridge is mounted by rotating the stepping motor and then slightly rotating reversely. On the other hand, when the drum cartridge is not mounted, the stepping motor runs at idle as it is. Thereafter, the image forming apparatus read out data by starting communication with the drum cartridge. If the data is readable, it is used for controlling the drum cartridge as it is. If the data is not readable, the operation for the absence of the appropriate drum cartridge is continued.

As described above, the rotating shaft exerting a rotational driving force on the drum cartridge is rotationally driven always when the power to the image forming apparatus is turned on, whereby it becomes possible to immediately place the drum cartridge and the image forming apparatus main assembly in a state that they are capable of communicating with each other with reliability by means of a minimum electromagnetic wave.

In the above-mentioned embodiment, the four color based full-color printer is used as the image forming apparatus of the present invention but the present invention is also applicable to an image forming apparatus, such as a monochrome printer, a color or monochrome copying apparatus, a facsimile apparatus, or the like. The present invention is further applicable, in addition to the image forming apparatus, an ordinary apparatus which transmits a rotational driving force to a load apparatus (unit) detachably mountable to an apparatus main assembly and provided with a noncontact memory.

### INDUSTRIAL APPLICABILITY

As described hereinabove, according to the present invention, there is provided an image forming apparatus including a process cartridge which is detachably mountable to an apparatus main assembly and includes a noncontact memory, antennas for performing communication of data stored in the noncontact memory with the apparatus main assembly, and a rotting shaft (axis) for receiving a rotational diving force from the apparatus main assembly which includes antennas for performing communication of data stored in the noncontact memory with the antennas of the process cartridge and a connection (coupling) portion for exerting the rotational driving force on the process cartridge. In the image forming apparatus, the apparatus main assembly rotationally drives the connection portion before reading out of the data stored in the noncontact memory which is mounted in the process cartridge, so that it becomes possible to effectively read out the data immediately and with reliability without outputting electromagnetic wave, more than necessary, to the noncontact memory mounted in the process cartridge which is detachably mountable to the apparatus main assembly.

While the invention has been described with reference to the Embodiments and structures disclosed herein, it is not confined to the details set forth and this application is intended to cover such modifications or changes as may come within the purpose of the improvements or the scope of the following claims.

1. An image forming apparatus, comprising:
an apparatus main assembly, and
a process cartridge detachably mountable to said apparatus main assembly, including driving force receiving means to be connected to driving means of said apparatus main assembly and a noncontact memory for noncontact data communication with receiving means of said apparatus main assembly,
wherein said apparatus main assembly performs rotational drive of the drive means before reading out data from the noncontact memory.

2. An apparatus according to claim 1, wherein the driving force receiving means and the noncontact memory are disposed on the same side of said process cartridge.

3. An apparatus according to claim 1, wherein the rotational drive of the drive means exerts a force on said process cartridge in a direction of narrowing a gap between the receiving means and the noncontact memory.

4. An apparatus according to claim 1, wherein said apparatus main assembly includes open/close means for being opened and closed at the time of mounting and demounting said process cartridge and an open/close detection member for detecting an open/close state of said open/close means, and performs rotational drive by the drive means when said open/close detection member detects that said open/close means is shifted from an open state to a close state.

5. An apparatus according to claim 1, wherein said process cartridge includes a photosensitive member, which is rotated by a driving force received by the driving force receiving means.
